(19) United States
(12) Patent Application Publication
(10) Pub. No.: US 2011/0274839 A1
(43) Pub. Date: Nov. 10, 2011

(54) Cantilevers for deposition

(75) Inventors: Joseph S. Fragala, San Jose, CA (US); R. Roger Shile, Los Gatos, CA (US); Sergey V. Rozhok, Skokie, IL (US)

(73) Assignee: NanoInk, Inc.

(21) Appl. No.: 13/064,766

(22) Filed: Apr. 13, 2011

Related U.S. Application Data
(60) Provisional application No. 61/324,167, filed on Apr. 14, 2010.
(60) Provisional application No. 61/326,103, filed on Apr. 20, 2010.

(51) Int. Cl. B05C 5/00; B05D 1/36; C23F 1/00; B05D 5/00

(52) U.S. Cl. 427/265; 118/300; 118/313; 427/256; 216/11

(57) ABSTRACT

Cantilever design for patterning from a cantilever tip can be improved with, for example, a recessed area surrounding the cantilever tip. A device for printing nanoscopic and microscopic patterns includes at least one cantilever having a front surface, a first side edge, a second side edge, and a first end which is a free end and a second end which is a non-free end. The front surface includes at least one first sidewall disposed at the first cantilever side edge and at least one second sidewall disposed at the second cantilever side edge opposing the first cantilever side edge, at least one channel, adapted to hold a fluid, disposed between the first and second sidewalls, wherein the channel, the first sidewall, and the second sidewall extend toward the cantilever free end but do not reach the free end, and a base region having a boundary defined by the first edge, the second edge, and the cantilever free end and also the first sidewall, second sidewall, and the channel, wherein the base region comprises a tip extending away from the cantilever front surface. Improved deposition can result. Fluidic inks comprising biomolecules can be patterned successfully.

### CROSS REFERENCE TO RELATED APPLICATIONS

This application claims benefit under 35 U.S.C. §119(e) to U.S. Provisional Patent Application No. 61/324,167, filed Apr. 14, 2010, which is incorporated herein by reference in its entirety, and also to U.S. Provisional Patent Application No. 61/326,103, filed Apr. 20, 2010, which is also incorporated herein by reference in its entirety.

### BACKGROUND

Recently developed surface nanolithography tools include, for example, Atomic Force Microscopy (AFM) cantilevers which can be used in a variety of technologies such as, for example, the Dip Pen Nanolithography (DPN)™ printing methods and related printing methods. DPN is a direct write technique that utilizes, for example, sharp tips such as, for example, AFM cantilevers as a pen for nanoscale deposition of chemical and biological fluids (often referred to as “inks”). AFM cantilevers have been used for DPN applications to generate a variety of nanoscale patterns. However, conventional AFM cantilevers were designed specifically for scanning applications and not for transferring fluids “inks” to a substrate to pattern it with microscale or nanoscale structures. The original cantilever design is basically a plain cantilever with a sharp probe (tip) at the end. Improved designs are needed, particularly for when commercial applications are used. For example, if inconsistency in ink deposition arises, this can generate a problem. The issue with inconsistency of ink deposition becomes even more vital while arrays of cantilevers are employed for parallel printing of multiple inks over larger areas. The variations in the size of the printed features should not be observed, or should be minimized, across the array for many applications.

### SUMMARY

Embodiments described herein include, for example, devices, instruments, and systems, methods of making devices, instruments, and systems, and methods of using devices, instruments, and systems. Another embodiment is a kit.

Embodiments disclosed herein are directed, for example, to a device comprising at least one cantilever comprising a front surface, a first side edge, a second side edge, and a first end which is a free end and a second end which is a non-free end. The front surface can include at least one first sidewall disposed at the first cantilever side edge and at least one second sidewall disposed at the second cantilever side edge opposing the first cantilever side edge, at least one channel, adapted to hold a fluid, disposed between the first and second sidewalls, wherein the channel, the first sidewall, and the second sidewall extend toward the cantilever free end but do not reach the free end, and a base region having a boundary defined by the first edge, the second edge, and the cantilever free end and also the first sidewall, second sidewall, and the channel. The base region can comprise a tip extending away from the cantilever front surface. A fluid ink can be stored in the channel and can flow to the base region, onto the tip, and be deposited from the tip to a substrate. While not limited by theory, the fluid ink appears to move off of the side wall region, moving into the channel and/or the base region as printing progresses. In at least some embodiments, surface tension can drive fluid from the channel toward the base region.

In one embodiment, the channel is tapered and has a gradually narrowing width toward the base region. The sidewalls can be also tapered, becoming more narrow as one moves to the free end and the base region. While not limited by theory, the base region can be configured to draw the fluid from the channel by, for example, a surface tension difference between the fluid over the base and the fluid in the channel. The base region can be substantially flush with the bottom surface of the channel.

In some embodiments, the first side edge and the second side edge are not parallel, and the cantilever narrows with approach to the free end.

Another embodiment comprises a method comprising: loading at least one ink onto a device comprising a plurality of cantilevers, as described herein, comprising at least one tip on each cantilever, depositing the ink from the plurality of cantilevers and tips to a substrate, wherein at least 80%, or at least 90%, or at least 95% of the tips show successful deposition of the ink onto the substrate. The method can be used to attempt to pattern over 1,000 features, and over 80%, or over 90%, or over 95% of the features can be successfully patterned.

In another aspect, a system is configured to deliver fluid to form microscopic or nanoscopic pattern, the system including at least one array of microbeams, and a control device configured to control a motion of the array of microbeams. Each microbeam can include an end portion, a tip protruding from a base region of the end portion, a channel along the micro beam and in fluidic connection with the base region, wherein the channel has a side wall, and wherein the base region is recessed from an outer surface of the side wall and extends to at least one side of the end portion.

In one embodiment, the base extends to three sides of the end portion. The base can be formed by masking the end portion completely.

In one embodiment, the channel is tapered and has a gradually narrowing width toward the base region. The base is configured to draw the fluid from the channel by a surface tension difference between the fluid over the base and the fluid in the channel. The base region can have an enlarged portion of the channel, and the enlarged portion has at least one side without a side wall.

The base region can have a lateral surface substantially flush with the bottom surface of the channel. The tip can be integrally formed with the base region.

In another aspect, a method of printing a microscopic or nanoscopic pattern on a surface is provided. The method includes depositing a fluid from a channel in a cantilever to the surface at an end portion of the cantilever. The end portion includes a base region having a tip thereon, and wherein the base region has no boundary at least at one side or has a side wall substantially lower than a side wall of the channel.

The depositing can include drawing the fluid from the channel toward the base region through a surface tension difference between the fluid in the base region and the fluid in the channel. The method can further include moving the cantilever end portion relative to the surface so that the fluid is delivered from the cantilever end portion to the surface.

The fluid can form a feature on the surface with a width of about 15 nm to about 100 microns, or about one micron to about 100 microns, such as a width of about one micron to about 15 microns. In the depositing, the cantilever can be made to contact the surface.

In another aspect, a method of manufacturing a micro cantilever is provided. The method includes providing an elongated beam having an end portion, forming a tip at the end portion, apply a mask having a tapered channel region along the beam, wherein the mask portion for the channel has an expanded portion that substantially encloses the end portion, and etching the elongated beam to form the tapered region and to a base region corresponding the expanded portion, wherein the base region extends completely through at least one side of the end portion.

In another aspect, a device is provided including a cantilever, the cantilever includes a channel, two side wall areas sandwiching the channel, a tip disposed at a free end portion of the cantilever, and a broadened channel area surrounding the tip. The broadened channel area extends completely through at least one side of the free end portion.

One embodiment provides a method comprising: providing a device according to an embodiment described herein, disposing an ink in the channel and on the tip of the device, and depositing the ink from the tip to a substrate.

Another embodiment provides an instrument adapted for printing an ink onto a substrate and comprising a device as described herein.

Another embodiment provides a kit comprising a device as described herein. Another embodiment provides that the kit further comprises instructions for use of the device as described herein. Another embodiment provides that the kit further comprises an ink for use with the device as described herein.

Another embodiment provides a method comprising: loading at least one ink onto a device comprising a plurality of cantilevers comprising at least one tip on each cantilever, depositing the ink from the plurality of cantilevers and tips to a substrate, wherein at least 80% of the tips show successful deposition of the ink onto the substrate. In another embodiment, at least 90% of the tips show successful deposition of the ink onto the substrate. In another embodiment, the method is used to pattern over 1,000 features, and over 80% of the features are successfully patterned. In another embodiment, the method the method is used to pattern over 1,000 features, and over 90% of the features are successfully patterned. In another embodiment, the method is used to pattern over 1,000 features, and over 95% of the features are successfully patterned.

In another embodiment, a device is provided comprising: an elongated cantilever having a first surface and a second surface, wherein the cantilever comprises: at least one tip disposed at an end portion of the cantilever; a recessed area on the first surface, wherein the recessed area comprises: a first elongated portion along the length direction of the cantilever; and a second expanded portion around the tip.

One important embodiment is use of the methods and devices described herein to make sensors and sensor elements.

At least one advantage for at least one embodiment comprises improved deposition, including, for example, improved deposition consistency, uniformity, and/or speed. Another advantage for at least one embodiment include fewer ink replenishments needed during the printing.

### BRIEF DESCRIPTION OF FIGURES

The patent or application file contains at least one drawing executed in color. Copies of this patent or patent application publication with color drawing(s) will be provided by the Office upon request and payment of the necessary fee.

FIG. 1A is a top plan view of known cantilevers 100. Cantilevers such as shown here can be obtained from NanoInk (Skokie, Ill.). The cantilevers form part of a linear array of cantilevers, wherein deposition is designed to occur from the tip of the cantilever to a substrate.

FIG. 1B is a top plan view of known cantilevers 100 during their normal operation including ink disposed on the cantilever for deposition to a substrate.

FIG. 1C is a top plan view of known cantilevers 100 having fluid droplets formed on their surfaces and moving away from the tip where deposition from the tip to a substrate should occur.

FIG. 2A is a perspective view of a known cantilever 210 having a recessed area 214 at the end portion 212 of the cantilever, where the recessed area 214 surrounds the tip 216.

FIG. 2B is a perspective view of a cantilever 220 having a first recessed area (channel) 221 and a second recessed area 224.

FIG. 2C is a perspective view of a cantilever 230 in accordance with an embodiment. The first elongated portion of the recessed area (channel) 231 is tapered. The upper surfaces of the side walls 235a, 235b are also tapered.

FIG. 2D is a side view of a cantilever 230 shown in FIG. 2C in one embodiment.

FIG. 2E is a side view, for one embodiment, of a cantilever 240 having a side wall 245b for the channel, and a side wall 244b for the second expanded portion of the recessed area 244. The side wall 244b has a height lower than that of the side wall 245b.

FIG. 3A illustrates diagram of multiple masks (shown in different color) used to fabricate the cantilever structures.

FIG. 3B illustrates diagram of multiple masks (shown in different color) used to fabricate the cantilever structures in accordance with embodiments disclosed herein.

FIG. 3C is a schematic diagram of the mask shown in FIG. 3A. The upper surfaces 350a, 350b of the side walls each have substantially parallel edges (as indicated by the 101 degree angle), i.e., the width of each of the upper surfaces is substantially constant along the length of the channel (shown as 12 um and 11 um at the two ends.)

FIG. 3D is a schematic diagram of the mask shown in FIG. 3B. The upper surfaces 360a, 360b of the side walls of the channel 331 each have tapered shapes, with a width narrowing by about 50% toward the end portion (from 9 um to 4 um). The angle between an inner edge of the upper surface 360b (101 degree) and the end edge of the channel is smaller than that between the outer edge and the end edge of the channel.

FIG. 4 is a top plan view of four different cantilever designs. #1 shows the case without a channel; #2 shows the case with an elongated channel that extends through the thickness of the cantilever, and the channel is tapered. #3 shows the case with an elongated channel that extends through the thickness of the cantilever, but the channel is not tapered. #4 shows the embodiment illustrated in FIG. 2B.

FIG. 5 is an image of a known multiple-pen array in which, for this embodiment, not all pens successfully produce patterns.

FIG. 6 is an image of a multi-pen array in accordance with an embodiment, where relatively successful printing is achieved with all or a substantial majority of all pens.

FIG. 7 is an image of a close-up view of the patterns printed with the cantilever array in accordance with an embodiment. The size of the dots is less than 1 um that corresponds 1 femtoliter deposition volume.

FIG. 8 is an image of an example of consistent ink deposition using the embodiment of FIG. 2C.

FIG. 9 is a close-up view of the image shown in FIG. 8.

FIG. 10 is an image of deposition of multiple nucleic acid, DNA, solutions using the embodiment of FIG. 2C.

FIG. 11 is a close-up view of the image shown in FIG. 10.

FIG. 12 is an image of an assay of proteins, of multiple cytokines, printed using the embodiment shown in FIG. 2C.

FIG. 13 illustrates (Top) Brightfield live image showing the printing of 6-micron dots of fluorescently tagged IgG onto a commercially available AFM cantilever. (Bottom) Fluorescent image of the printed domains on the cantilever.

FIG. 14 illustrates four different fluorescently tagged proteins printed on custom cantilever arrays having different spring constants.

### DETAILED DESCRIPTION

Introduction

All references cited in this application are hereby incorporated by reference in their entirety.

Priority U.S. Provisional Patent Application No. 61/324,167, filed Apr. 14, 2010, is incorporated herein by reference in its entirety.

References cited herein may aid the understanding and/or practicing the embodiments disclosed herein. Examples of prior art references relating to printing, fabrication methods, and/or fluid flow include U.S. Pat. Nos. 6,642,129; 6,635,311, 6,827,979, 7,034,854, and 2005/0235869 which describe fundamental dip pen printing methods and associated technology of fabrication methods and fluid fow. See also, for example, US patent publications, 2008/0105042; 2009/0023607; 2009/0133169; 2010/0071098. Other examples include U.S. Pat. No. 7,610,943 and US patent publications 2003/0166263; 2007/0178014; and 2009/0104709. Other examples include U.S. Pat. Nos. 7,690,325 and 7,008,769. See also, U.S. Pat. Nos. 7,081,624; 7,217,396; and 7,351,303. See also, US Patent Publication Nos. 2003/0148539 and 2002/0094304.

Other examples include U.S. Pat. Nos. 5,221,415 and 5,399,232 to Albrecht et al. and the article entitled “Microfabrication of Cantilever Styli for the AFM”, J. Vac. Sci. Technol. A8 (4) July/August 1990 which disclose a process for making passive AFM cantilevers.

Microfabrication is generally described in M. J. Madou, Fundamentals of Microfabriation, The Science of Miniaturization.

See also, commercial printing pen and pen array products, as well as printing instruments, and other related accessories, commercially available from NanoInk, Inc. (Skokie, Ill.).

Embodiments disclosed herein can relate to more consistent and controllable deposition of fluidic “inks” on solid surface in the femto- and attolitter volume range. In some embodiments, a new design for an Atomic Force Microscope (AFM) cantilever with microfluidic channels can improve consistent delivery of controlled amounts of chemical and biological fluids on the nanoscale. In contrast to conventional cantilever design, a cantilever in accordance with an embodiment can be fabricated with a recessed channel to retain and direct fluids toward a sharp tip at the distal end of the cantilever. The recessed area and/or the area between the recess and the edge of the cantilever can be tapered toward the tip. The tapers can result in liquids on these surfaces being driven toward the tip by surface tension. In such a design, fluids can be self-driven to the tip and can form a consistent ink flow from the tip to solid substrate. The side walls forming the channel can be also tapered, becoming more narrow as approaching the tip.

### Microbeams and Cantilevers

Cantilevers and microbeams are known in the art including use for printing inks and imaging and manipulating surfaces. For example, “diving board” cantilevers and “A-frame” cantilevers are known. The elongated sides of the cantilever can be parallel or tapered. The cantilever can comprise a gap portion disposed at the bound end of the cantilever. The cantilevers can optionally comprise a tip at the free end. Cantilevers can be adapted for active or passive printing. Actuation methods include thermal and electrostatic. Cantilevers can form parts of arrays of cantilevers including one dimensional and two dimensional arrays.

Typical microscopic or nanoscopic printing apparatuses or systems deposit fluid using one or more elongated members reminiscent of a conventional dip pen. The elongated members can be in the form of microbeams, such as cantilevers. Cantilevers usually have an end fixed to a substrate, and another end that is free. The cantilevers can be fabricated using known technologies, such as MEMS microfabrication technologies. See, for example, references cited in the Introduction. The cantilevers, and the tips, can comprise inorganic materials such as, for example, silicon nitride, silicon dioxide, or any other suitable semiconductor material or material used in the semiconductor industry. Cantilevers, and the tips, can also comprise softer organic materials like polymers and elastomers such as silicone polymers.

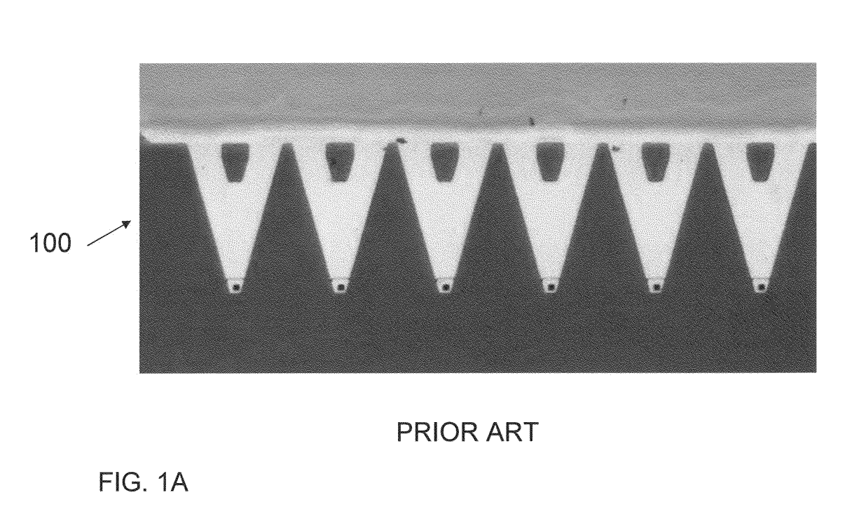

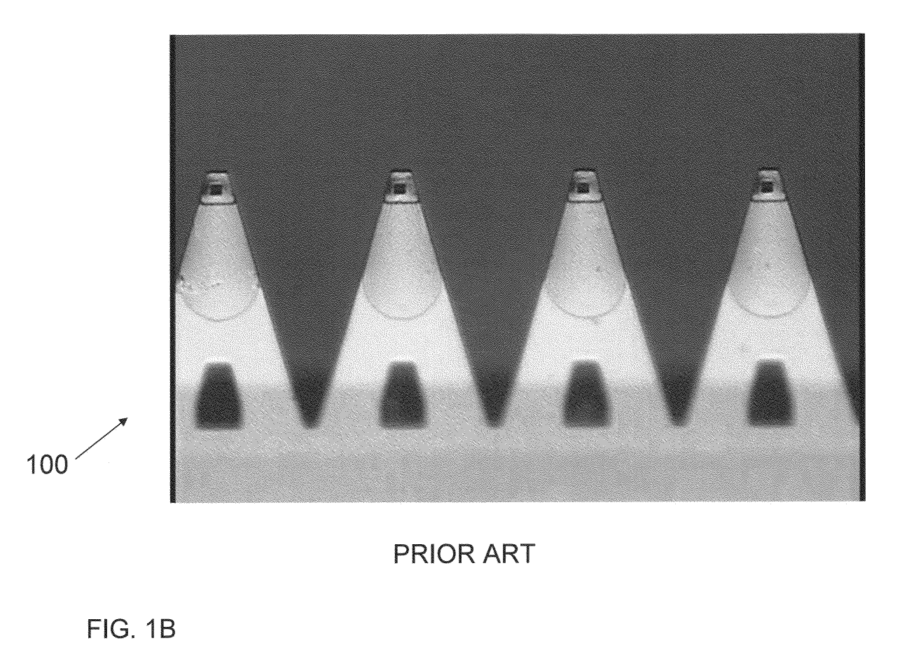

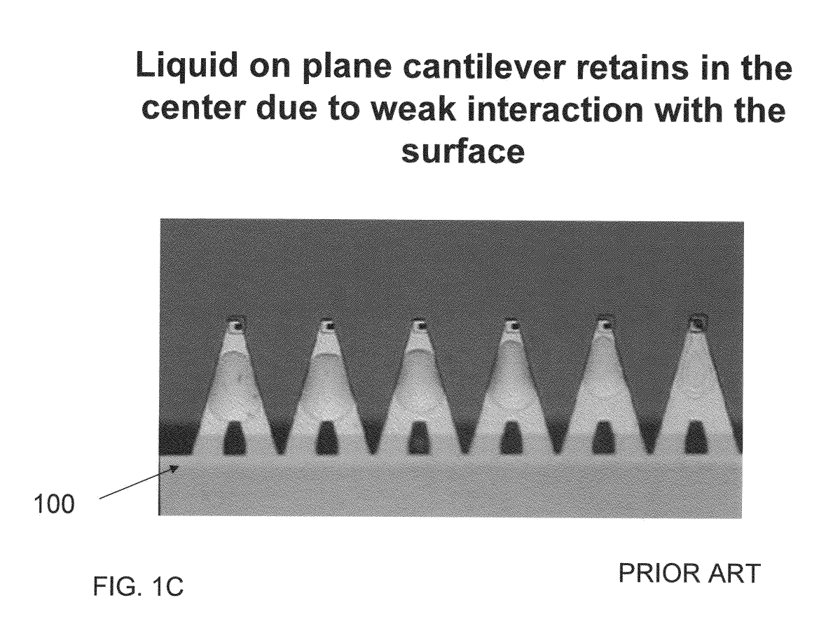

In DPN applications, as described herein, a cantilever surface works as a pool that stores and delivers inks to the probe. The process of inking can involve dipping cantilever into a micro fluidic channel or reservoirs with inks (e.g., inkwells). Typically inks spread over the cantilever surface in a form of a thin liquid film. FIG. 1 shows a top plan view of an array of conventional cantilevers 100 having fluid droplets formed on their surfaces. FIG. 1A shows the cantilever array without the ink. FIGS. 1B and 1C show the cantilevers having ink disposed on them. The inks can form droplets (which are thermodynamically more stable than a thin film of liquid) in the center of the cantilever with no connectivity to the probe. See, in particular, FIG. 1C. Unsatisfactory printing patterns can result, in some cases, from these cantilevers. In some embodiments, the fluid activity on the cantilever can lead to inconsistent printing.

The cantilever or microbeam can comprise a front surface, a back surface, a first side edge, a second side edge, a first end, and a second end. The front surface can comprise the tip, for example. The back surface can be free of a tip, for example. The first and second side edges can be elongated. The first end can be the free end. The second end can be associated with the base or be the non-free end. A base region can be associated with the first end, or the free end. The base region can comprise the tip.

If desired, more than one tip can be disposed on each cantilever.

In one embodiment, the cantilever front surface is hydrophilic. Water droplet can form a contact angle of, for example, less than 50 degrees, or less than 40 degrees, or less than 30 degrees. After the cantilever is fabricated, the cantilever can be used directly without further treatment to adjust surface hydrophilicity. Hence, in one embodiment, the cantilever front surface is not treated to change the hydrophilicity or hydrophobicity. Alternatively, the cantilever could be treated, either the whole cantilever front surface or selected parts of the front surface.

If desired, the tips can be surface modified to improve printing. For example, the surface of the tip can be made more hydrophilic. Tips can be sharpened.

In one embodiment, surface of the cantilever is treated with compounds which can passivate a surface to adsorption, such as hydrophilic compounds such as, for example, compounds comprising alkyleneoxy or ethyleneoxy units (e.g. PEG), which forms a biocompatible and hydrophilic surface layer. One advantage of this surface treatment is, for example, the inhibition of protein absorption, and thus the reduction of the activation energy required for protein transport from tip to surface. In the absence of this surface treatment, an ink comprising protein may not in some cases wet the untreated cantilever.

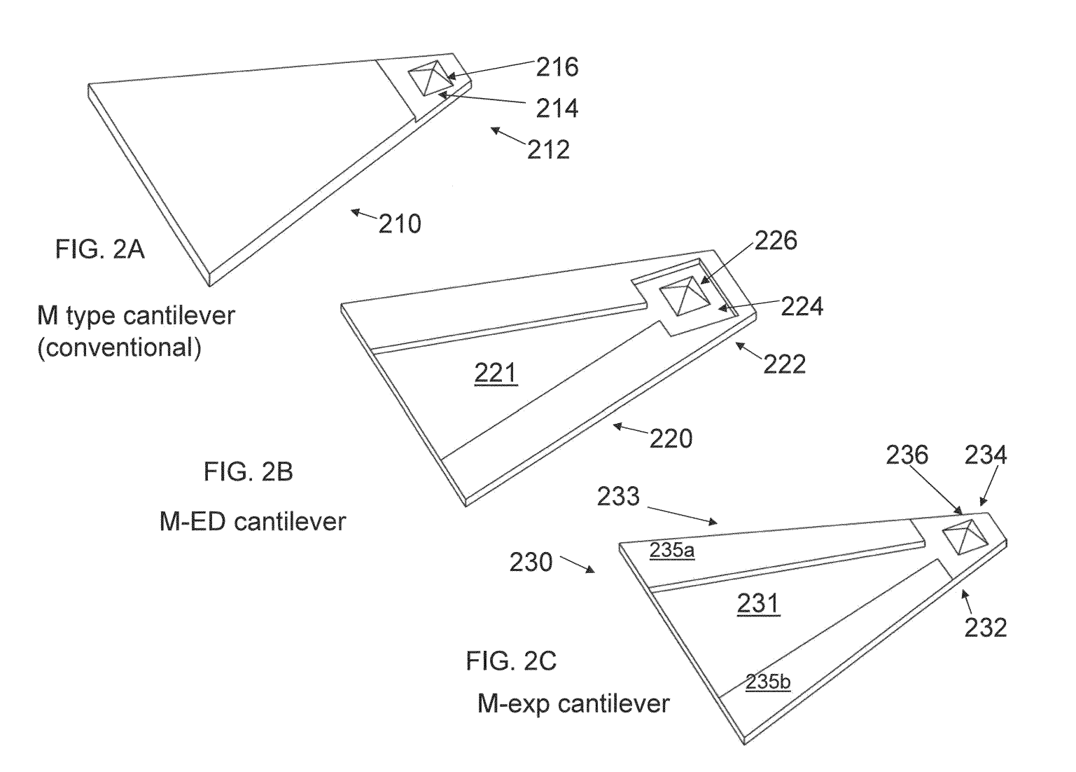

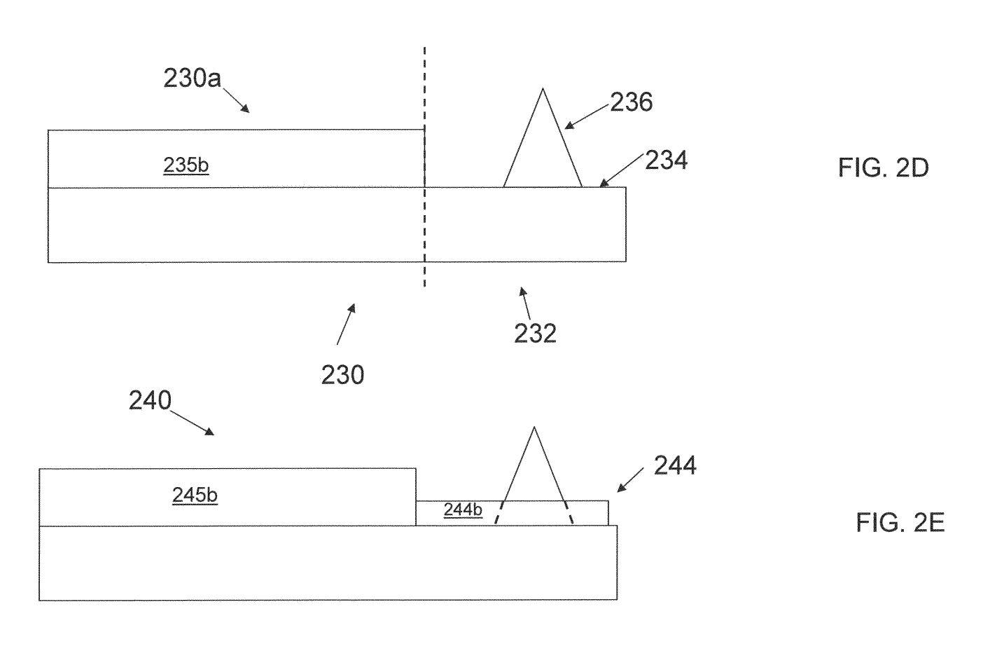

FIG. 2A is a perspective view of a conventional cantilever or microbeam 210, which includes an end portion 212 having a base region 214 in the form of a well. A tip 216 is disposed in the base region. The end portion 212 can be a free end of the cantilever. The opposing end to the left of FIG. 2A can be the fixed end of the cantilever.

### Channels and Base Regions

Channels are generally known in the microfluidics and MEMS arts. Channels can function both to store fluid and also transport fluid. Channels can be formed from side walls, including opposing sidewalls, and a floor and also can be enclosed if desired. One end of the channel can further comprise a wall. One end of a channel can also open into a larger area and not be walled in. For example, a channel may open up into a base region as described herein so that ink can be in fluid communication with and flow from the channel into the base region.

In one embodiment, as illustrated in FIG. 2B, the cantilever 220 has a tapered recessed slot, referred to as a channel 221, which can extend from the middle of the cantilever, or from a second, fixed end portion towards a first, free end portion 222. Due to the microcavity effect of the channel 221 and its tapered profile, the inks can be held in the recessed area and can be forced to the tapered end by the surface tension. Thus, inks can be self-driven toward the end portion 222 and into the base region 224 to be deposited from the tip 226. Thus, a more consistent ink deposition from the probe to substrate surface can be achieved. In addition, the channel 221 allows storing a larger amount of inks. Thus, larger areas can be deposited before the ink needs to be replenished.

### FIG. 2C

In the embodiment shown in FIG. 2C, the cantilever 230 comprises a tapered channel 231 recessed from a cantilever front surface 233. The channel 231 is tapered and has a gradually narrowing width toward the base region.

In FIG. 2C, the front surface 233 can have four edges, and can include two side wall regions 235a and 235b. The base region 234 is disposed at the end portion 232. The base region 234 has a tip 236 extending away from the front surface of the base region. In this embodiment, the side wall regions 235a, 235b do not extend into the base regions 234. Thus, unlike the structures shown in FIGS. 2A and 2B, the tip 236 is not surrounded by a side wall, and the base region 234 extends throughout the end portion 232 such that the bottom surface of the base region 234 is substantially flush with the bottom surface of the channel 231.

In the embodiment shown in FIG. 2C, the base region 234 is configured to draw the fluid (ink) from the channel 231 by a surface tension difference between the fluid over the base region 234 and the fluid in the channel 231. In particular, as the base region has essentially no boundaries, a larger fluid droplet can be formed in the base region 234 around the tip 236. The larger droplet tends to draw fluid from the channel 231 having a smaller surface area through the surface tension difference.

One embodiment, FIG. 2D, is a side view of the cantilever 230 shown in FIG. 2C. The cantilever 230 can be divided into a reservoir portion 230a and the end portion 232. The tip 236 protrudes from a bottom surface of the base region 234, which does not have a side wall as does the channel region. The base region 234 can be defined by the side walls of the channel, the channel, and the three edges of the end portion 232, but is substantially without boundaries at the three edges.

In an embodiment shown in FIG. 2E, the cantilever 240 has a base region 244 with a side wall 244b, which has a height smaller than that of the side wall 245b of the channel. The base region can extend completely through the other two edges without side walls thereon. Alternatively, the base region 244 can optionally have side walls at all three edges of the end portion.

Without boundaries or side walls, or with side walls lower than those of the channel, the base region can have less constraint on the fluid droplet held therein. Thus, the base regions 234, 244 can have larger droplets of fluid formed thereon. The larger droplets can have smaller surface tension compared with the fluid in the channel, and the fluid can be drawn from the channel into the base region by the surface tension difference. Thus, the droplet at the base region surrounding the tip can effectively provide a suction force to the fluid in the channel.

The embodiments of the cantilever designs shown in FIGS. 2B and 2C can accomplish short and long scale printing (extended printing wherein larger numbers of features can be printed).

### Dimensions and Other Parameters for Cantilevers

One skilled in the art can vary the dimensions depending on the application. Dimensions can be adapted, for example, depending on if the cantilever is an A-frame type or a diving board type. Also, the type of ink can be considered in designing the cantilever. For example, viscosity of the ink can be considered. For example, DNA inks can be very viscous. One can use an A-Frame type cantilever with higher stiffness and spring constant.

In one embodiment, for example, the area of the cantilever front surface can be less than about 10,000 square microns. In another embodiment, the area of the cantilever front surface can be less than about 2,700 square microns.

In one embodiment, the sidewalls (both first and second) can have a height which is at least about 200 nm. In another embodiment, the sidewalls (both first and second) can have a height which is at least about 400 nm. The height of the first and second sidewalls can be the same.

In one embodiment, the first and second sidewalls can have a maximum width and a minimum width, and the maximum width can be larger than the minimum width, so that the side walls are tapered. For example, the side wall can have a maximum width of about three microns to about 20 microns, or about five microns to about 15 microns. The side wall can have a minimum width of about one micron to about ten microns, or about two microns to about eight microns. The difference in maximum and minimum sidewall width can be, for example, about three microns to about then microns.

In one embodiment, the channel can have a length of about 10 microns to about 200 microns, or about 50 microns to about 175 microns, or about 75 microns to about 160 microns. In one embodiment, the length can be about 90 microns to about 130 microns.

In one embodiment, the channel can have a maximum width of about 50 microns or less, or about 35 microns or less, or about 25 microns or less. The range can be, for example about ten microns to about 50 microns, or about 20 microns to about 30 microns. This maximum width can be at the back end of the cantilever. The width can narrow as one moves down the channel toward the free end and the base region.

In one embodiment, the channel can have a minimum width of about three to 25 microns, or about five to ten microns, or about six microns. This zone of minimum width can provide a boundary for the base region.

In one embodiment, the difference between the maximum and minimum channel width can be, for example, about five microns to about fifty microns, or about ten microns to about thirty microns, or about 15 microns to about 25 microns.

In one embodiment, the channel has its minimum width at the boundary between the channel and the base region, namely the “throat” (or a first channel end), while having its maximum width at the opposite end close to the non-free end of the cantilever, namely the “tail” (or a second channel end). The width of the tail (or second channel end) can be, for example, about 5 to 100 microns, or about 15 to 75 microns, or about 25 to 50 microns. The width of the throat (or first channel end) can be, for example, about 1 to 25 microns, or about 2 to 15 microns, or about 3 to 9 microns. The distance between the throat and the tip can be, for example, about 1 and 25 microns, or about 2 to 11 microns.

The outer edge of the sidewall can be also characterized by a first angle, and the inner edge of the sidewall can be characterized by a second angle with respect to the perpendicular cross plane of the cantilever, wherein the first angle is larger than the second angle. For example, the first angle can be about one to 20 degrees larger, or about 3 to about 10 degrees larger than the second angle. This can provide a tapering effect.

The width of the cantilever can be, for example, about 10 microns to about 100 microns, or about 20 microns to about 75 microns, or about 10 microns to about 30 microns, or about 15 microns to about 25 microns.

The tip height and tip radius can be values known in the art, including the arts of AFM imaging and use of AFM and similar tips to transfer ink from tip to surface. For example, tip height can be about 20 microns or less, or about 10 microns or less, or about five microns or less. The tip radius can be, for example, about 50 nm or less, or about 25 nm or less. Tip radius can be, for example, about 15 nm. Nanoscopic tips can be made and used.

For an array of multiple cantilevers, the pitch between the cantilever tips can be also adjusted as known in the art. Pitch can be, for example, about 50 microns to about 150 microns, or about 60 microns to about 110 microns.

In one embodiment, the first side wall, the second sidewall, and the channel are all tapered to become more narrow when moving toward the free end, and the first and second sidewalls narrow by at least four microns, and the channel narrows by at least 15 microns.

In one embodiment, the cantilever comprise silicon nitride. The thickness of such cantilever can be, for example, about 1,000 nm or less, or about 800 nm or less, or about 600 nm or less, or about 400 nm or less.

The spring constant of the cantilever can be also adapted. Examples include about 0.1 μm to about 10 N/m, or about 0.3 N/m to about 0.7 N/m. In one embodiment, the spring constant is 0.6 N/m.

### Inks

The inks can be adapted for loading, flow, deposition, and use with the cantilevers and microbeams described herein. For example, ink viscosity can be adapted. The concentration of solids and liquids can be adapted. Surface tension can be adapted. Surfactants can be used if needed. Additives and drying agents can be used. Aqueous and non-aqueous inks can be used and solvent proportions can be adapted for mixed solvent systems.

Inks comprising one or more biological moieties are particularly of interest. For example, proteins, nucleic acids, lipids, and the like can be used.

Inks can be also adapted for introduction of the ink onto the cantilever and use with inkwells to guide the ink to desired locations for loading.

### Methods of Fabrication

Microfabrication methods are described in various references cited in the Introduction.

In a preferred embodiment, a sharpening mask, which has the integrated triangular fluidic channel portion for forming the channel and the connected square portion for forming the base region, can be used for sharpening the tip. The cantilever mask, which patterns the nitride, is not the original mask (M-ED) but the narrower M-type mask. This mask has narrow side areas which function to funnel the ink on those sections towards the tip. This two mask combination results in the improved ink utilization as well as the more uniform ink patterns.

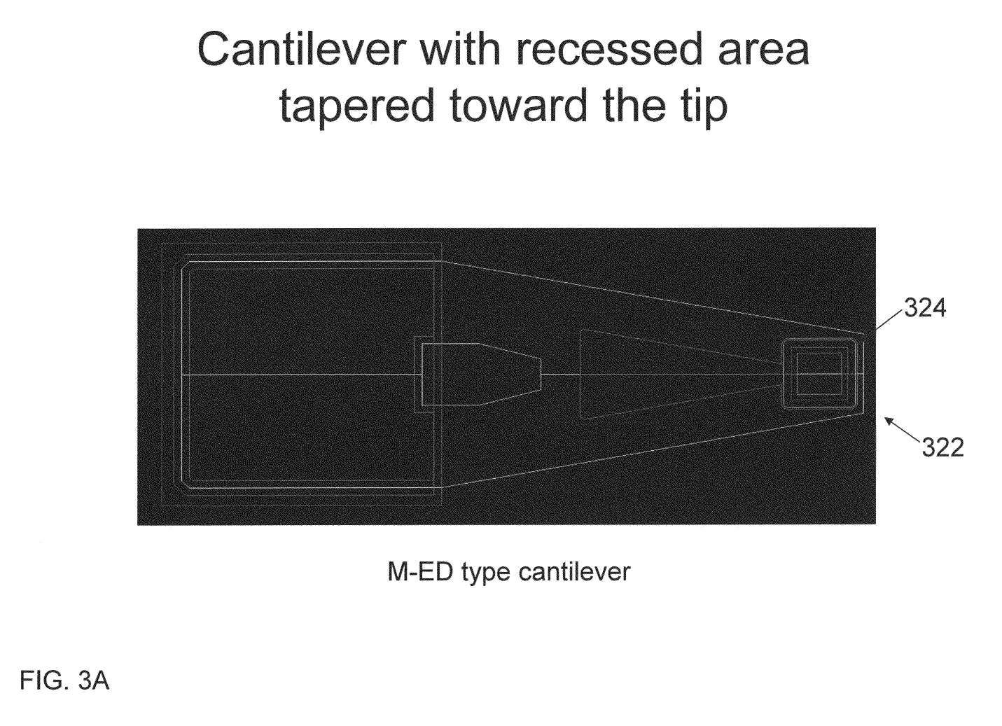

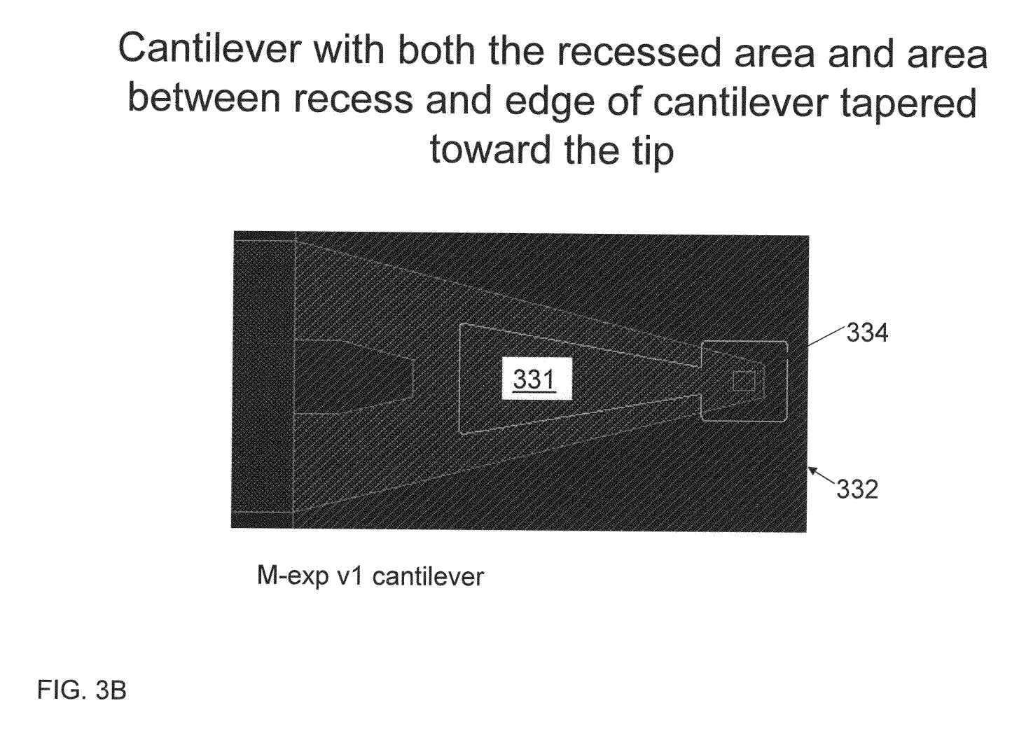

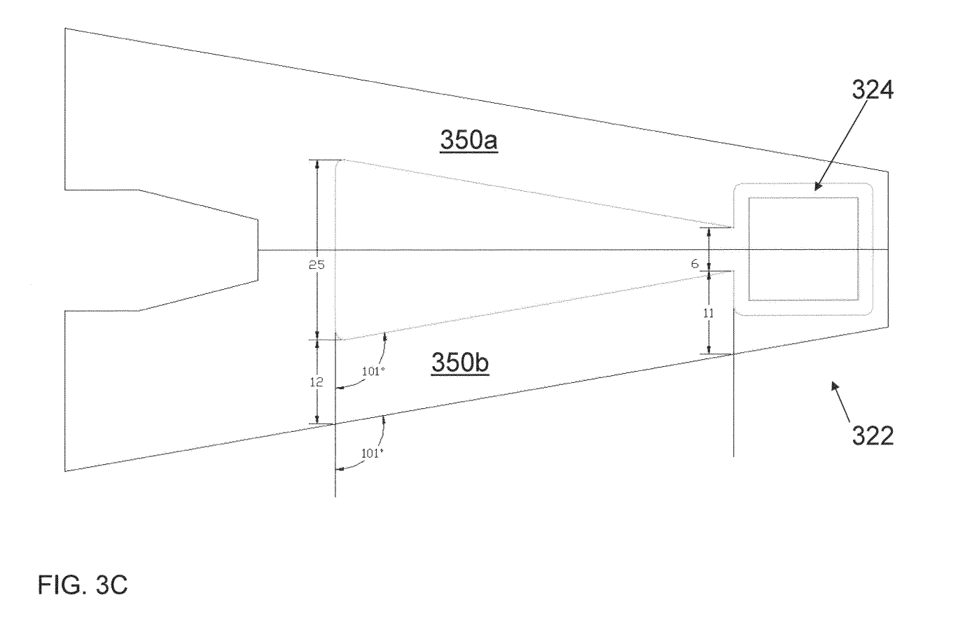

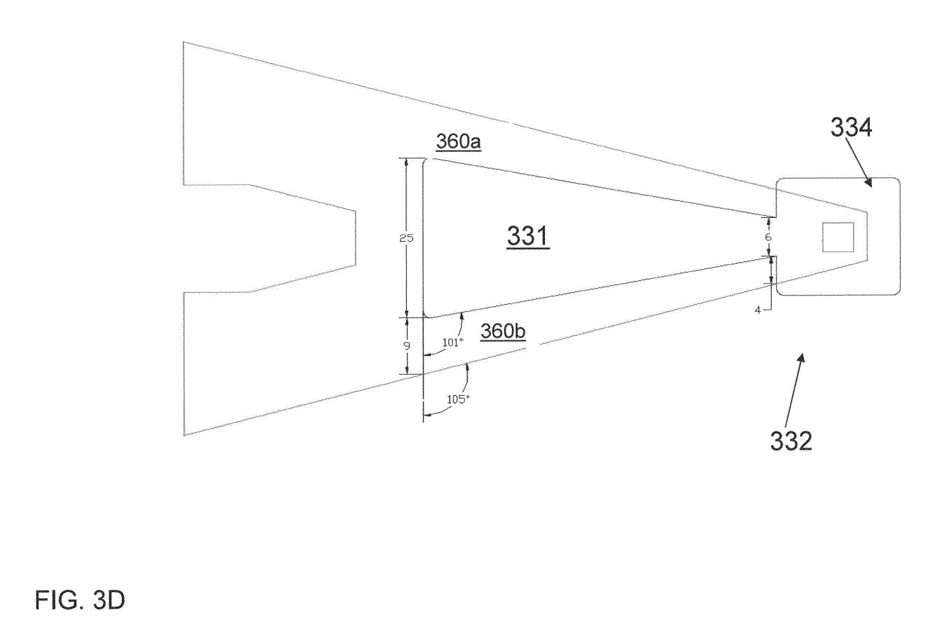

Top plan views of the masks for fabricating the cantilevers 220, 230, respectively, are shown in FIGS. 3A and 3B (see also FIGS. 3C and 3D, respectively). In FIG. 3A, it is shown that the square mask portion 324 for the base region is smaller than the end portion 322. The subsequently formed base region is thus surrounded by side walls. In FIG. 3B, it is shown that the square mask portion 334 is larger than the entire end portion 332. The resulting base region 234 thus essentially does not have a boundary. In FIG. 3B, the mask portion 334 for the base region 234 can be an expanded extension of the mask portion 331 for the channel 231. In addition, the masks of FIGS. 3B and 3D provide for substantial tapering in the sidewall (unlike in FIGS. 3A and 3C).

Silicon nitride cantilevers with integrated pyramidal tips can be fabricated by a method similar to that described by Albrecht et al. (Albrecht et al., Microfabrication of cantilever styli for the atomic force microscope. Journal of Vacuum Science & Technology A: Vacuum, Surfaces, and Films 1990; 8:3386-3396). Subsequent to crystallographic etching of the pyramidal pits and removal of the masking layer from the silicon wafer, an oxide layer is formed. This oxide is then patterned to form a region which includes the pyramidal pits and an adjoining triangular area. This oxide layer can serve the role of sharpening the tip, and/or otherwise controlling the apex radius and shape of the pit (Akamine, Low temperature thermal oxidation sharpening of microcast tips. J Vac Sci Technol B 1992; 10:2307-2310). While not limited by theory, compressive stress in the oxide layer can cause the oxide to expand in the direction normal to the surface. Near the bottom of the pyramidal pit this expansion can be frustrated by the proximity of the opposite face. This can result in a change of the cross sectional profile from v-shaped to cusped, and a reduction in the radius of curvature at the apex.

The oxide layer can also serve the role of forming a mold for a channel in the subsequently-formed silicon nitride cantilever. A step that is already performed to make sharp tips can thus be modified to make an open channel on the cantilever. Open channels for fluid transport are used for the inkwell products developed and sold by NanoInk, Inc. (Skokie, Ill.).

In some alternative embodiments, the recessed base portion can have a side wall on one, two, or three sides. The side walls can be lower than the side wall regions of the channel.

### Method of Printing

For rapid fabrication of millions of features over macro areas, DPN printing can use MEMS devices with high-density 1D and 2D pen arrays. These MEMS devices can significantly expand DPN capabilities in parallel printing of multiple materials but at the same time demand exceptional performance of each pen within the array.

One of the challenges that nanolithography is facing these days is nanoscale patterns with high-throughput, reproducibility and low cost.

Reproducible high-density chemical and biological patterns on solid substrates can be achieved using the systems disclosed herein. Such patterns can be useful for research and commercial applications related to nano and biotechnology, for example for spotting high-density protein and nucleic acid, DNA nano- and microarray, fabrication of lab-on-a-chip sensors, integrated circuits and MEMS.

A method of printing a microscopic or nanoscopic pattern on a surface is provided. The method includes depositing a fluid from a channel in a cantilever described above to the surface at an end portion of the cantilever. The end portion comprises a base region having a tip thereon, and wherein the base region has no boundary at least at one side or has a side wall substantially lower than a side wall of the channel. The depositing comprises drawing the fluid from the channel toward the base region through a surface tension difference between the fluid in the base region and the fluid in the channel. By moving the cantilever end portion relative to the surface, the fluid can be delivered from the cantilever end portion to the surface at different locations.

The resulting patterns can have features with a width of about 15 nm to about 100 microns, or about 100 nm to about 50 microns, or about one micron to about 25 microns, such as about one micron to about 15 microns. The cantilever end portion, particularly the tip, can be in contact with the surface during the depositing process. Features can be one micron or less in lateral dimension (e.g., diameter or line width).

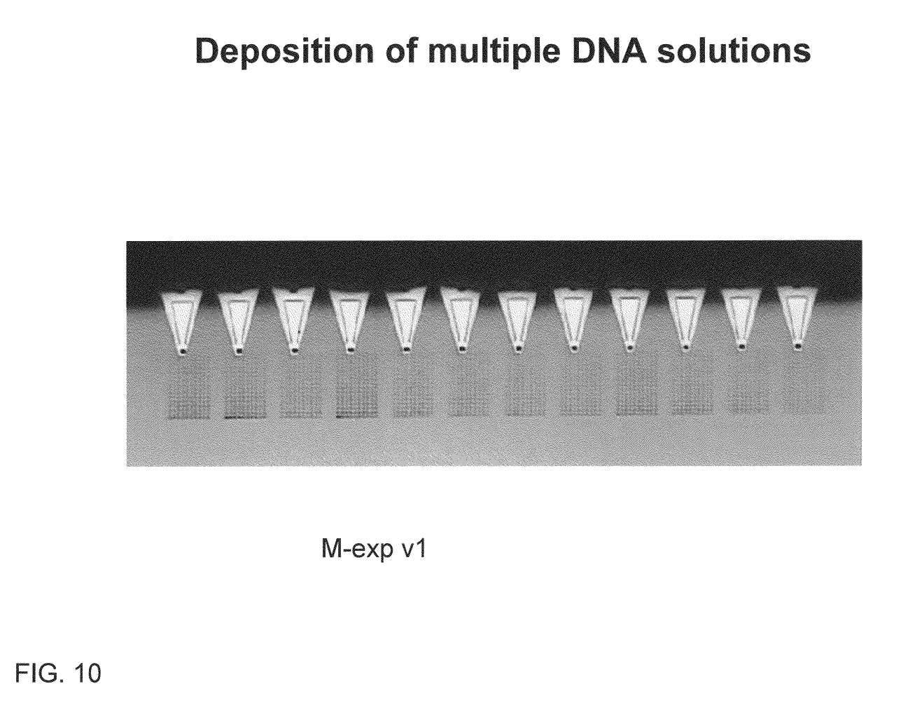

The embodiments disclosed herein improve printing capabilities of the DPN for fabrication of the high- and biological chips or MEMS devices (for any liquid ink DPN printing, not limited to bio or MEMS), as further illustrated in FIGS. 10-12. Using cantilevers with microfluidic channels can improve product quality and increases production volume.

Kits can be provided which comprise the devices described herein. The kits can also comprise at least one ink, at least one substrate, at least one inkwell, one or more other accessories, and/or at least one instruction sheet to use the kit.

Instruments can be also made to use the devices described herein. For example, printing instruments can be obtained from NanoInk, Inc. (Skokie, Ill.) including the DPN 5000 or NLP 2000 instruments. See, for example, US patent publication 2009/0023607 (NanoInk, Inc) describing a nanolithographic instrument.

### Additional Embodiments (“Ed Embodiments”)

At least eleven additional embodiments are further described for ED (“extended delivery”).

One embodiment, called ED1, comprises a device comprising: an elongated cantilever having a first surface and a second surface, wherein the cantilever comprises: at least one tip disposed at an end portion of the cantilever; a recessed area on the first surface, wherein the recessed area comprises: a first elongated portion along the length direction of the cantilever; and a second expanded portion around the tip.

ED2. The device of Embodiment ED1, wherein the second expanded portion of the recessed area has side walls at the end portion of the cantilever.

ED3. The device of Embodiment ED1, wherein the second expanded portion of the recessed area extends throughout the end portion of the cantilever.

ED4. The device of Embodiment ED1, wherein the second expanded portion has at least one side without a side wall.

ED5. The device of Embodiment ED1, wherein the first elongated portion of the recessed area has two side walls, and wherein the second expanded portion of the recessed area has at least one side wall lower than the two side walls of the first elongated portion of the side wall.

ED6. The device of Embodiment ED1, wherein the first elongated portion is configured as a channel for delivering fluid toward the second expanded portion of the recessed area, and wherein the first elongated portion has a tapered shape with a narrowing width toward the second expanded portion.

ED7. The device of Embodiment ED1, wherein the first elongated portion of the recessed area has two side walls, and wherein the two side walls each have substantially the same width along the length of the cantilever.

ED8. The device of Embodiment ED1, wherein the second expanded portion of the recessed area has a substantially square shape.

ED9. The device of Embodiment ED1, wherein the second expanded portion of the recessed area extends throughout the end portion of the cantilever, wherein the first elongated portion of the recessed area has two side walls, and wherein each of the two side walls has a an upper surface with a narrowing width toward the end portion.

ED10. The device of Embodiment ED1, wherein the second expanded portion of the recessed area extends throughout the end portion of the cantilever, wherein the first elongated portion of the recessed area has two side walls, wherein each of the two side walls has a an upper surface with a narrowing width toward the end portion, and wherein the width of the upper surface of each of the two side walls narrows by at least 10% toward the end portion.

ED 11. The device of Embodiment ED 1, wherein the second expanded portion of the recessed area extends throughout the end portion of the cantilever, wherein the first elongated portion of the recessed area has two side walls, wherein each of the two side walls has a an upper surface with a narrowing width toward the end portion, and wherein the width of the upper surface of each of the two side walls narrows by at least 50% toward the end portion.

### Working Examples

The figures, including photographs, illustrate several working examples.

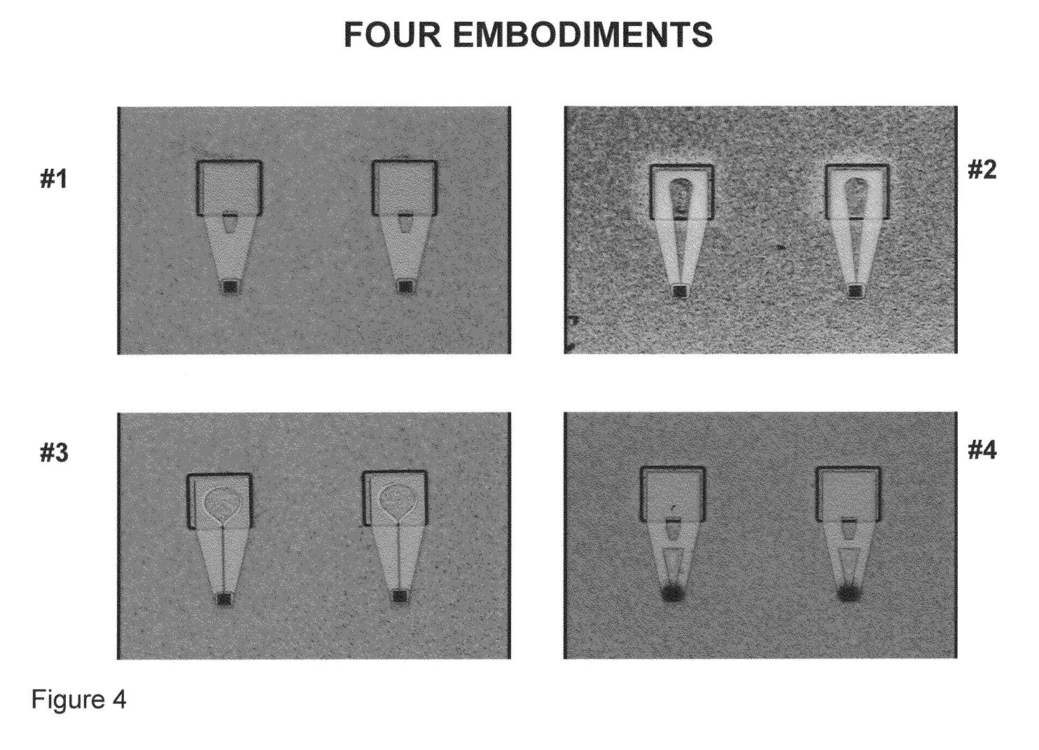

FIG. 4 illustrates actual developments that have been employed in DPN process for fabrication of biological and chemical arrays. “#1” is a conventional cantilever without slot or recess. “#2” has a tapered slot extending through the length of the cantilever, terminating at the well in the end portion surrounding the tip. “#3” has non-tapered slot running the length of the cantilever, terminating at the well in the pedestal. “#4” has a recessed area in the end portion of the cantilever and connected to the tapered recessed channel.

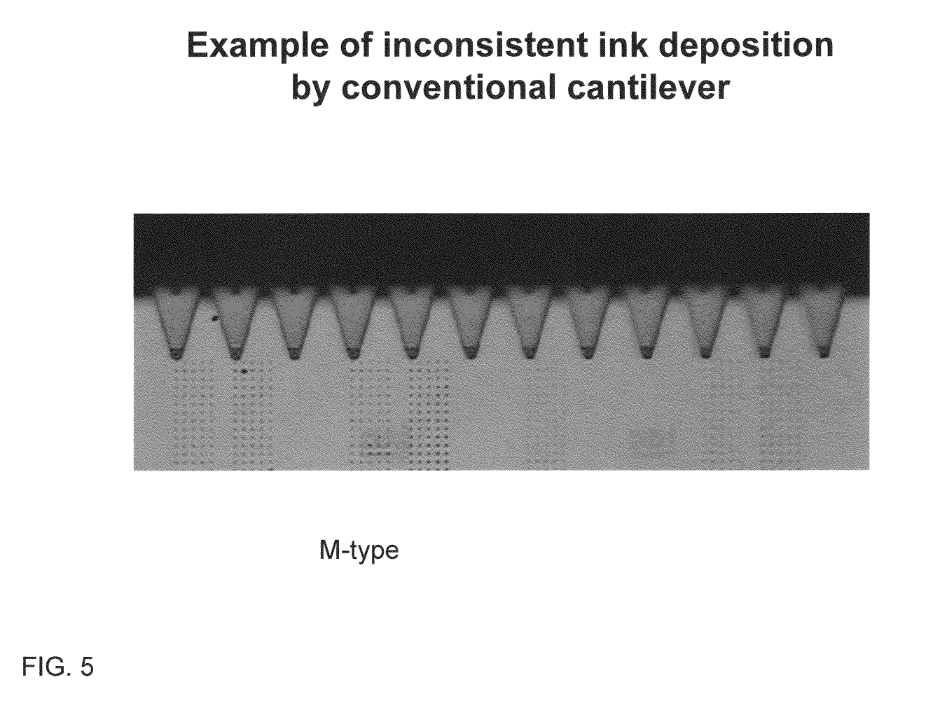

Variations in cantilever characteristics may alter the print results. For example, FIG. 5 demonstrates printing problems with using a multiple-pen array in which not all pens produce patterns. For example, in the third cantilever from the left, no spots are present.

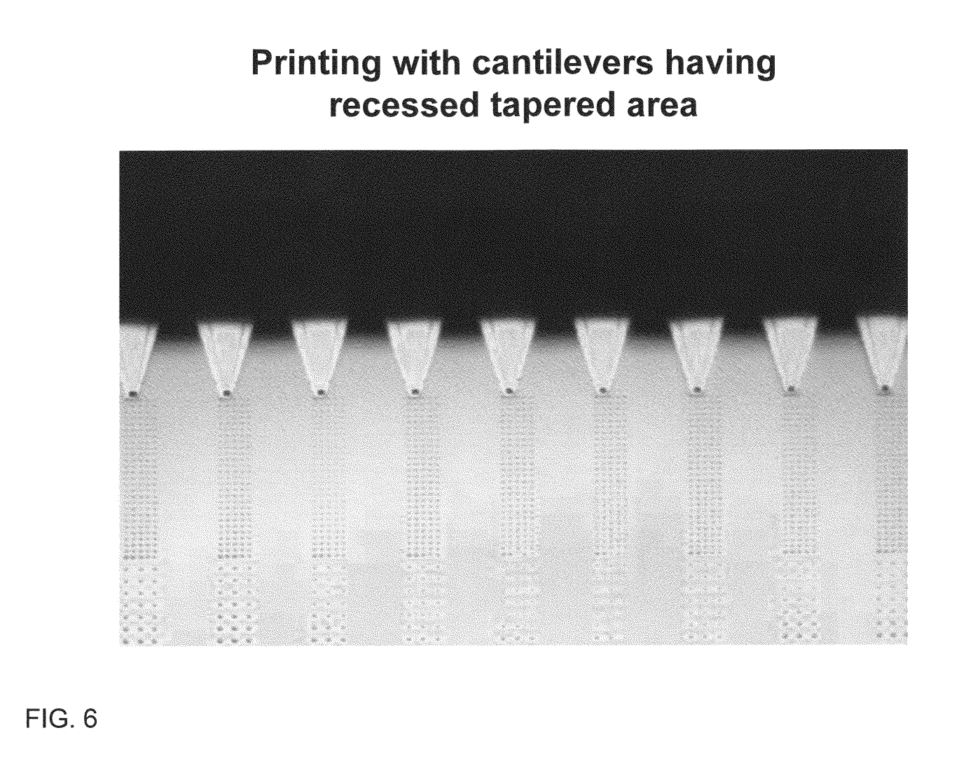

In contrast, FIG. 6 illustrates successful printing with all, or substantially all pens. For example, more than 80% of the pens can print simultaneously, or more than 90%, or more than 95%, or more than 98% of the pens can print simultaneously. Numerous experimental data provide evidence that microfluidic channels embossed over the cantilever surface in accordance with the embodiments disclosed herein facilitate fluid flow from the cantilever to the tip.

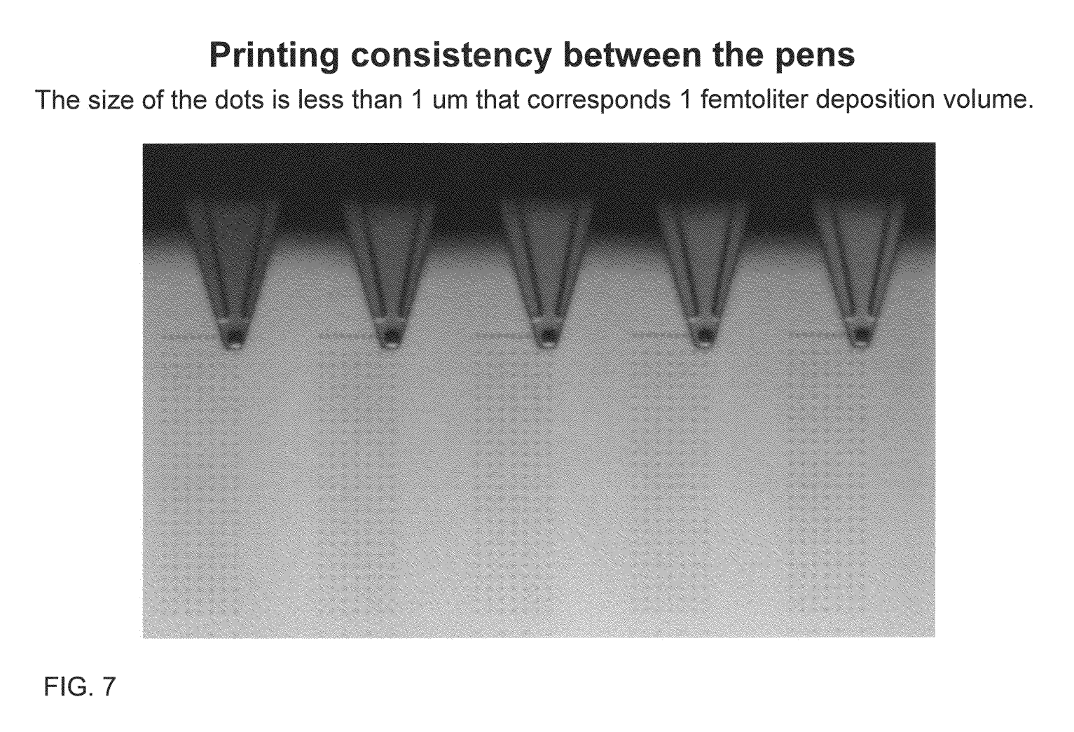

In addition, FIG. 7 is an image of a close-up view of the patterns printed with the cantilever array in accordance with an embodiment. The size of the dots is less than 1 um that corresponds 1 femtoliter deposition volume.

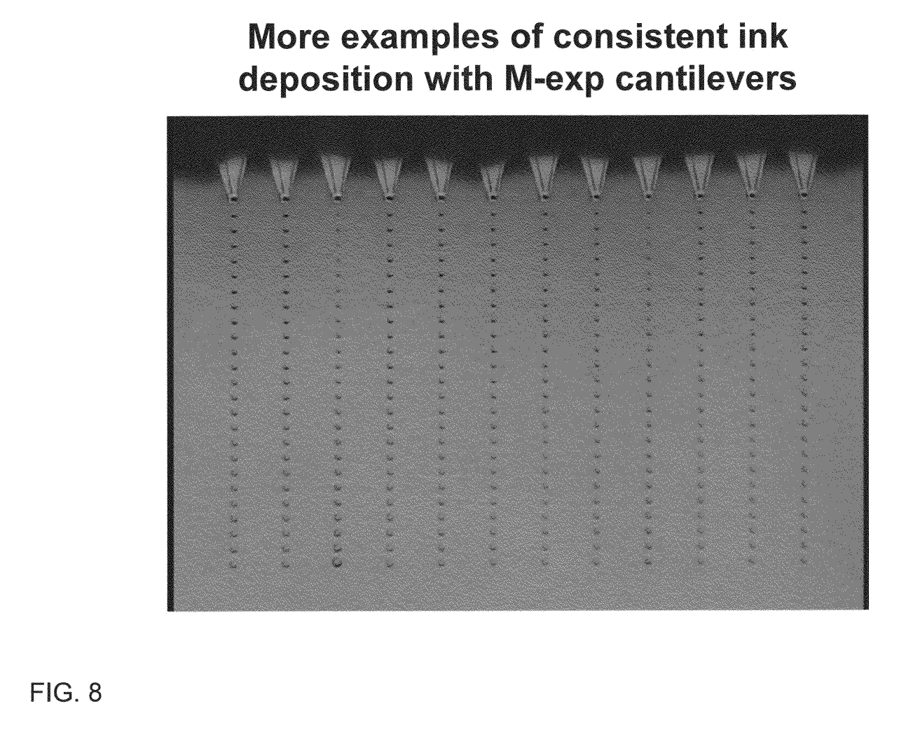

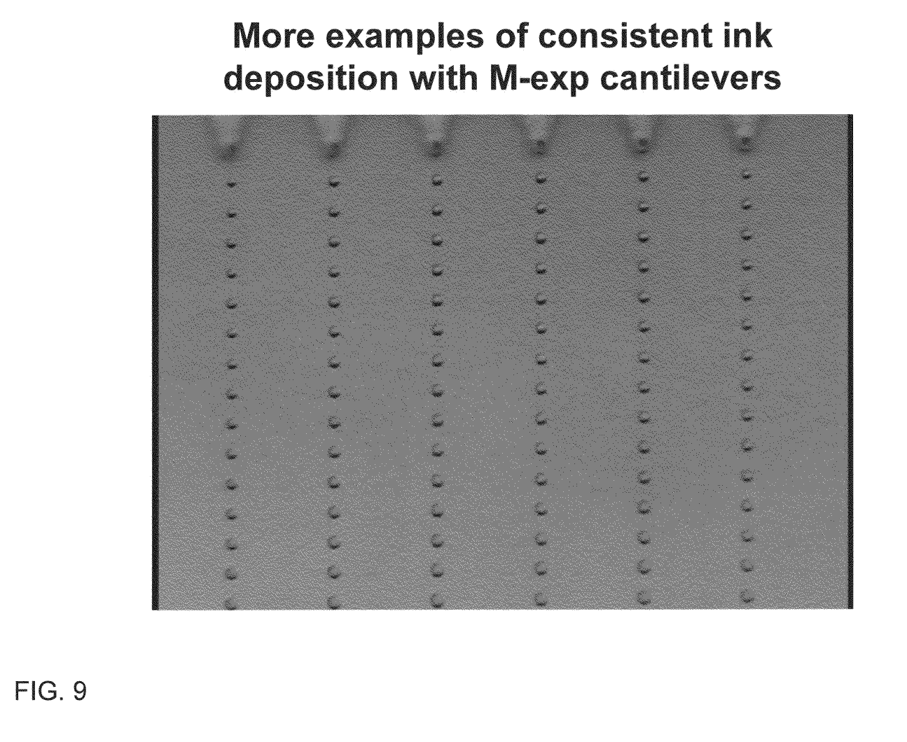

In addition, FIG. 8 is an image of an example of consistent ink deposition using the embodiment of FIG. 2C. Furthermore, FIG. 9 is a close-up view of the image shown in FIG. 8.

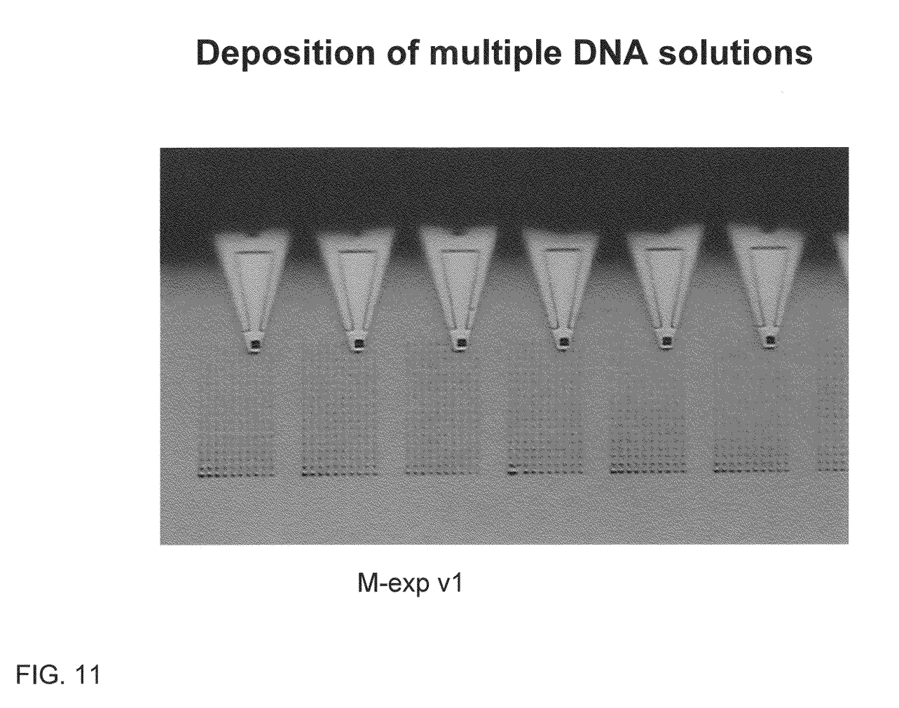

Still further, FIG. 10 is an image of deposition of multiple nucleic acid, DNA, solutions using the embodiment of FIG. 2C. FIG. 11 is a close-up view of the image shown in FIG. 10.

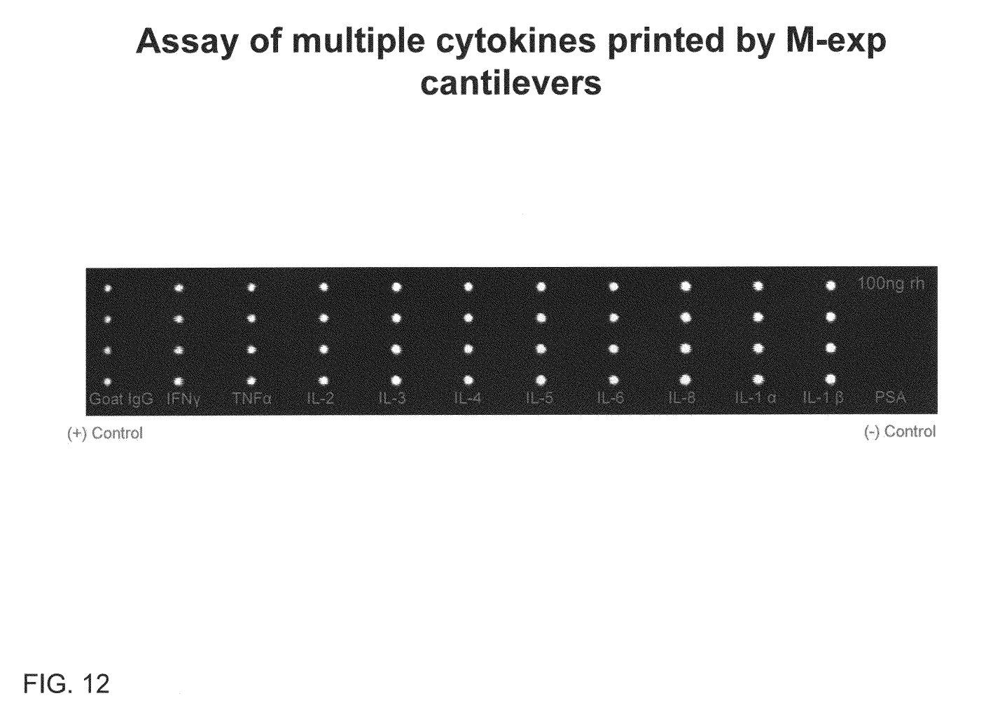

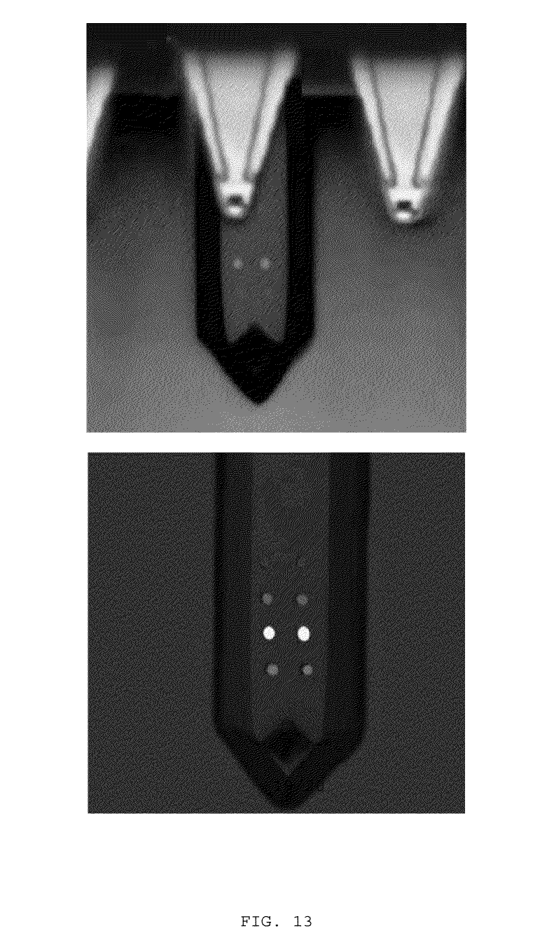

FIG. 12 is an image of an assay of proteins, of multiple cytokines, printed using the embodiment shown in FIG. 2C.

### Additional Embodiments (“Sensor Embodiments”)

In one application, sensors can be prepared using the devices and methods described herein. See, for example, U.S. provisional application Ser. No. 61/326,103 filed Apr. 20, 2010, which is hereby incorporated by reference in its entirety. For example, a need exists to provide better methods for multiplexed printing of small structures. In addition, a need exists to develop more sensitive, accurate, versatile, robust, and low cost sensing methods, and methods for making and using these improved sensors. In particular, biologically-related sensing is an important commercial need, and multiplexed biological structures are needed. For example, many areas of medicine will be advanced by better sensors. Also needed are high throughput methods for making and using sensors.

Embodiments provided herein include, for example, devices, articles, kits, and compositions, and methods of making and methods of using the same, wherein sensor or sensor elements can be prepared.

One embodiment provides, for example, multi-plexed addressable printing to prefabricated structures at the nano- and micro-scale. The printing can be used to form sensors. The prefabricated structure can be, for example, a cantilever.

One embodiment provides, for example, a method comprising: providing at least one tip, providing at least one substrate, wherein the substrate comprises at least one sensing element, disposing at least one ink composition on the tip so that the tip comprises ink composition, and moving the tip comprising ink composition relative to the sensing element so that ink composition is deposited from the tip to the sensing element for form a modified substrate. The tip can be part of a cantilever structure a a microbeam structure as described herein.

At least one advantage for at least one embodiment includes improved spatial resolution in preparing sensing elements.

At least one advantage for at least one embodiment is ability to sense multiple analytes at the same time.

At least one advantage for at least one embodiment is more sensitive sensing.

Instruments, materials, devices, accessories, and kits can be obtained from NanoInk, Inc. (Skokie, Ill.).

Micro and nano electromechanical (MEMS and NEMS) sensors are known in the art. Sensors can be physical sensors or chemical sensors. Sensors can be used, for example, to diagnose biological diseases. Sensors can be used to detect multiple analytes simultaneously.

Technical literature describing sensing and related devices and methods include, for example, (1) Sauran et al., Anal. Chem., 2004, 76, 3194-3198; (2) Dhayal et al., J. Am. Chem. Soc., 128, 11 (2006), 3716-3721; (3) Dutta et al., Anal. Chem., 2003, 75, 2342-2348; (4) Belaubre et al., Applied Physics Letters, 2003, 82, 18, 3122, (5) Yue et al., Nanoletters, 2008, 8, 2, 520-524; (6) Lynch et al., Proteomics, 2004, 4, 1695-1702.

Patent literature includes, for example, US Patent Publication numbers 2010/0086992 (Himmelhaus et al.) and 2010/0086735 (Baldwin et al.).

In addition, direct write lithography and nanolithography are known in the art. For example, an ink composition can be disposed on the tip and the ink composition can be transferred from tip to a substrate as described above. Dip pen methods can be used. Nanoscale and microscale printing can be carried out. Technical literature includes: US patent publication 2010/0048427 (matrix ink); US patent publication 2009/0143246 (matrix ink); US patent publication 2010/0040661 (stem cells); US Patent publication 2008/0105042 (two dimensional arrays); US patent publication 2009/0325816 (two dimensional arrays); US patent publication 2008/0309688 (viewports); US patent publication 2009/0205091 (leveling); US patent publication 2009/0023607 (instrument); US patent publication 2002/0063212 (DPN); US patent publication 2002/0122873 (APN); US patent publication 2003/0068446 (protein arrays); US patent publication 2005/0009206 (protein printing); US patent publication 2007/0129321 (virus arrays); US patent publication 2008/0269073 (nucleic acid arrays); US patent publication 2009/0133169 (inking of cantilevers); US patent publication 2008/0242559 (protein arrays); U.S. provisional application 61/225,530 (hydrogel arrays); U.S. provisional application 61/314,498 (hydrogel arrays); U.S. provisional application 61/324,167 (improved pens); Jang et al., Scanning, 31, (2000), 1-6; U.S. Pat. No. 7,034,854 (inkwells); and WO 2009/132321 (polymer pen lithography)

Cantilevers and tips disposed at the end of cantilevers are known in the art. Tips can be used which are solid and non-hollow. They can be free of an aperture. They can be nanoscopic tips. They can be scanning probe microscope tips, including atomic force microscope tips. They can have a tip radius of less than 100 nm, for example, or less than 50 nm, or less than 25 nm, for example. Tips can be sharpened and cleaned by methods known in the art. Tips can be surface treated to improve deposition as known in the art. See, for example, US patent publication 2008/0269073 (nucleic acid arrays); US patent publication 2003/0068446 (protein arrays); and US patent publication 2002/0063212 (DPN). Plasma cleaning can be used as needed.

Sensing elements are known in the art and can be, for example, a cantilever, whether microcantilever or nanocantilever, a membrane, or the like. Sensing elements can relate to optical, electrochemical, and electrical sensing. Sensing elements can be used which function as a substrate for biologically reactive binding moieties or capture agents.

Microcantivers and nanocantilevers are known in the art. See, for example, Goeders et al., Chem. Rev., 2008, 108, 522-542; see U.S. Pat. Nos. 7,207,206 and 7,291,466. Microcantilevers can be AFM cantilevers. Cantilevers can be A-frame type or diving board type. The cantilever width, length, and shape can be increased or reduced, if desired, to improve the sensing performance and printability.

Microfluidic channels can be present on the cantilever to guide fluid flow to the tip and act as a reservoir.

Tipless cantilevers can be used.

Cantilever structures can comprise and be made of materials such as, for example, silicon nitride, silicon, and polymeric materials.

Sensing elements can be hydrophobic or hydrophilic on their surfaces.

Sensing elements can be cleaned before use. For example, sensing elements can be cleaned with plasma cleaning. The time for cleaning can be adapted to provide the best results.

Sensing elements can be treated with surface coatings before use. For example, reactive silane coatings can be used.

Sensing elements can be treated to have coating which block adsorption of molecules and materials such as block adsorption of proteins.

Ink compositions are known in the art. They can comprise at least one patterning composition or material to be patterned such as nanoparticles or other nanostructures. The ink composition can comprise at least one carrier and at least material to be deposited.

The carrier can be, for example, an aqueous carrier system comprising water alone or water supplemented with one or more other solvents, preferably miscible with water. The pH of the carrier can be adapted.

The material to be deposited can be a molecule such as for example a biomolecule. Biomolecules include, for example, proteins, peptides, nucleic acids, DNA, RNA, enzymes, and the like.

The ink composition can comprise at least one synthetic polymer, including polymers designed to produce hydrogels upon further reaction (e.g., hydrogel precursors).

The ink composition can also comprise additives such as, for example, surfactants.

High resolution can be achieved. For example, the distance between feature boundaries printed can be 10 microns or less, five microns or less, one micron or less, or 500 nm or less.

Deposition is known in the art including deposition at the nanoscale involving transfer of material from a tip to a substrate. For example, the tip can move relative to the substrate, or the substrate can move relative to the tip. Contact methods can be used wherein the tip and substrate can be contacted.

In one embodiment, ink jet printing is not carried out.

Femtoliter, picoliter, and in some cases nanoliter amounts of molecules can be deposited.

The deposition can result while the tip is moving in a lateral dimension relative to the substrate, to create lines including curvilinear lines or straight lines, or while the tip is stationary in a lateral dimension relative to the substrate to create dots or circles.

Dwell time, rate of movement, and deposition rate can be adapted to provide desired line width or dot diameter.

Printing at the same spot can be repeated at the spot.

Relative humidity during printing can be adapted to improve printing. For example, relative humidity over 50%, or over 60%, can be used for printing.

The material on the sensing element can be a capture agent as known in the art. The capture agent can be adapted and selected to bind with target molecules as known in the art. Specific binding can be achieved.

Protein, peptide, and antibody capture agents can be used. Multiplexed capture agent systems can be used including multiplexed proteins, peptides, and antibodies.

Target molecules/samples

The sample can comprise one or more target molecules as known in the art. The target molecules can be adapted and selected to bind with the capture agent as known in the art.

The binding of a capture agent to a target molecule can provide detectable changes in a cantilever such as, for example, stress, resonance, and deflection.

After printing, the sensor elements can be stored in higher relative humidity to maintain hydration states for the spots, including proteins.

Applications include, for example, disease screening, point mutation analysis, blood glucose monitoring, diagnostics, tissue engineering, interrogation of sub-cellular features, use with lab-on-a-chip, basic research, and chemical and biological warfare agent detection. Other applications are described in references cited herein.

Viruses can be analyzed.

Cells including stem cells can be analyzed.

Antibodies and antigens can be analyzed.

Attogram sensitivity can be achieved.

Instrumentation, devices, and methods can be used from NanoInk, Inc. (Skokie, Ill.) including: NLP 2000 System; DPN® Pen Arrays: Type M; DPN® Pen Arrays: Type E DPN® Inkwell Arrays: Type M-12MW; DPN® Substrates: Silicon Dioxide.

Inks and inkwells can be prepared according to procedures for printing protein inks. One can use AlexaFluor labeled inks mixed with protein ink.

Cantilevers can be hydrophobic in order for uniform dot sizes to be achieved. Treat all cantilevers in oxygen plasma cleaner for 20 seconds on medium at 200 mtorr. Evaporate Glycidoxy propyl Trimethoxy Silane (GTMO) onto the underside of the cantilevers as usual. 2 hours at 80 deg C. and overnight without GTMO at 100° C.

Tips can be bled 4 times for 6 micron dots at 50% humidity. Printing is then accomplished 1 tip at a time.

To ensure that the same pressure is applied to for each dot printing and that a nice round dot is formed, one can position the writing tips 25 microns above the cantilever to be printed on. Then one can move the stage up 20 microns and check for printing. One can move the stage up 1 micron at a time until a single uniform dot is printed.

If a different ink has a smaller dot size (due to the different fluorophore), one can re-ink at exactly the same place to make a larger dot.

One can keep the sample hydrated before imaging.

Additional examples are described:

N-proteins and their conjugates were purchased from Invitrogen:

Normal Goat catalog #10200 5 ml 5 mg/ml

Normal mouse IgG Catalog # 10400C 5 ml

Normal Rabbit IgG Catalog #10500C 5 ml

Donkey anti-sheep IgG (H+L) Alexa Fluor® 350 Catalog #A21097 0.5 ml*2 mg/mL*

Chicken anti-goat IgG (H+L) Alexa Fluor® 488 Catalog #A21467 0.5 ml*2 mg/mL*

Donkey anti-mouse IgG (H+L) Alexa Fluor® 546 Catalog #A10036 0.5 ml*2 mg/mL*

Chicken anti-rabbit IgG (H+L) Alexa Fluor® 647 Catalog #A214430.5 ml*2 mg/mL*

These proteins were split into different sections. Those to be used later were vacuum sealed and placed in a −80° C. freezer. Normal-protein solutions to be used right away were diluted to 2.5 mg/ml with 1×PBS buffer. Conjugate IgG proteins were diluted 20× or 500× before reacting.

To print, the protein can be combined in a 5:3 ratio with protein ink solution. This was then pipette into an M-Type inkwell using 0.3 μl to fill 3 reservoirs with each type of protein.

NanoInk M-EXP tips, as described above and claimed below, were used in this experiment and were oxygen plasma cleaned for 20 seconds at 200 mtorr prior to use that day.

Silicon wafers diced, marked with a crude features with a diamond scribe. The individual Si chips were thoroughly cleaned by sonicating in ultrapure Acetone for 20 minutes followed by sonication in ultrapure Isopropanol for 20 minutes. The chips were then placed in a glass Petri dish with glycidoxy propyl trimethoxy silane (GPTMS). The GPTMS was placed by syringe into several caps from centrifuge tubes placed in the glass Petri dish. The cover was placed on the Petri dish and then was set into an oven at 100° C. for 2 hours to evaporate the GPTMS onto the substrate. The GPTMS was then removed and the substrates were reinserted into the oven at 80° C. overnight. This ensured the hydrophobicity of the substrate was adequate for printing a polar ink and that the proteins would be able to bind to the epoxy surface permanently.

The protein prints at several different humidity conditions. The most common used was 50% at high humidity very large dots are printed with good consistency and at low humidity smaller dots are printed.

The ink can be bled before printing. For larger 6 micron dots 4 bleeding dots are usually sufficient to then print another 3-10 repeatable dots. For smaller 1-2 micron dots 8-10 bleeding dots are needed to print 10-20 features.

To print the different proteins close to one another, advanced pattern sequences were used which would spot the first tip on the substrate and move subsequent tips to deposit features very close to the first dot. Several different printing pitches were utilized: 11 microns, 16.5 microns, and 33 microns.

### Reactions:

After printing the substrate and ink are placed in a humid container (70-100% humidity) and allowed to react for 3 hours at room temperature. This allows the protein to bind to the surface.

The substrate is then washed with milli Q water then shaken with a mixture of PBS and 0.1% tween 20.

Then a large drop of casein protein solution was placed over the reaction area as a blocking agent and allowed to bind to the unreacted epoxy on between the printed features. This was allowed to react for 1 hour at high humidity.

The substrate was again washed as above.

The three conjugate antibodies were diluted to 100 μg/ml and mixed together in a single solution. This solution was placed in a large droplet over the reaction area and allowed to react for 1 hour at high humidity.

The substrate was washed a final time and observed under a fluorescent microscope.

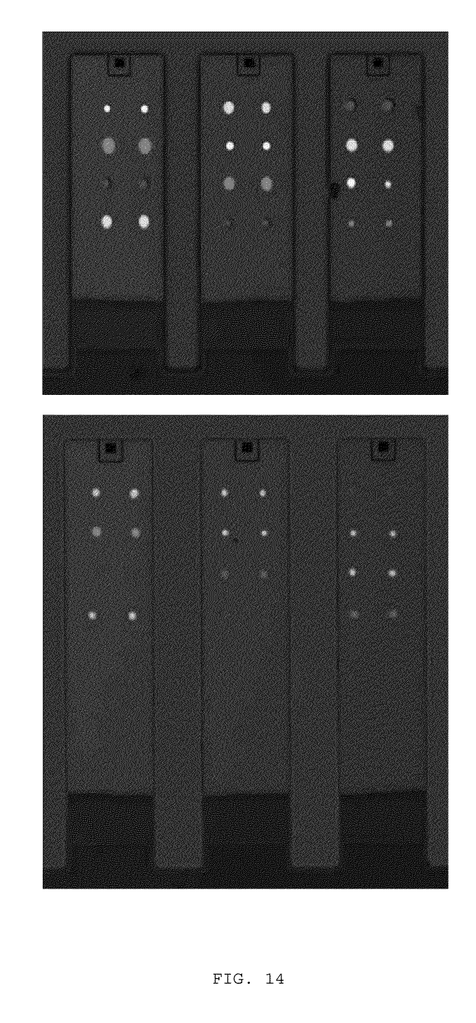

In addition, for sensor applications, FIG. 13 illustrates (Top) Brightfield live image showing the printing of 6-micron dots of fluorescently tagged IgG onto a commercially available AFM cantilever. (Bottom) Fluorescent image of the printed domains on the cantilever.

Finally, FIG. 14 illustrates for sensor applications four different fluorescently tagged proteins printed on custom cantilever arrays having different spring constants.

What is claimed is:

1. A device comprising:
at least one cantilever comprising a front surface, a first side edge, a second side edge, and a first end which is a free end, and a second end which is a non-free end,
wherein the front surface comprises:
at least one first sidewall disposed at the first cantilever side edge and at least one second sidewall disposed at the second cantilever side edge opposing the first cantilever side edge;
at least one channel, adapted to hold a fluid, disposed between the first and second sidewalls, wherein the channel, the first sidewall, and the second sidewall extend toward the cantilever free end but do not reach the free end, and
a base region having a boundary defined by the first edge, the second edge, and the cantilever free end and also the first sidewall, second sidewall, and the channel,
wherein the base region comprises a tip extending away from the cantilever front surface.

2. The device of claim 1, wherein the channel is tapered and has a gradually narrowing width as the channel extends toward the base region.

3. The device of claim 1, wherein the first and second sidewalls are tapered and have a gradually narrowing width as they extend towards the base region.

4. The device of claim 1, wherein the base region is substantially flush with the bottom surface of the channel.

5. The device of claim 1, wherein first side edge and the second side edge are not parallel, and the cantilever narrows with approach to the free end.

6. The device of claim 1, wherein the area of the cantilever front surface is less than about 10,000 square microns.

7. The device of claim 1, wherein the area of the cantilever front surface is less than about 2,700 square microns.

8. The device of claim 1, wherein the sidewalls have a height which is at least about 200 nm.

9. The device of claim 1, wherein the sidewalls have a height which is at least about 400 nm.

10. The device of claim 1, wherein the channel has a length of about 10 microns to about 200 microns.

11. The device of claim 1, wherein the channel has a maximum width of about 50 microns or less.

12. The device of claim 1, wherein the cantilever front surface is hydrophilic.

13. The device of claim 1, wherein the cantilever front surface is not treated to change the hydrophilicity or hydrophobicity.

14. The device of claim 1, wherein the tip is nanoscopic tip.

15. The device of claim 1, wherein the tip is a solid tip without a hole or aperture.

16. The device of claim 1, wherein the tip is characterized by a tip radius of less than about 20 microns.

17. The device of claim 1, wherein the tip has a tip height of at least about 3 microns.

18. The device of claim 1, wherein the first side wall, the second sidewall, and the channel are all tapered to become more narrow when moving toward the free end.

19. The device of claim 1, wherein the first side wall, the second sidewall, and the channel are all tapered to become more narrow when moving toward the free end, and the first and second sidewalls narrow by at least four microns, and the channel narrows by at least 15 microns.

20. The device of claim 1, wherein the cantilever is an A-frame cantilever or a diving board cantilever.

21. A system configured to deliver fluid to form microscopic or nanoscopic patterns, the system comprising:
at least one array of microbeams; and
a control device configured to control a motion of the array of microbeams;
wherein each microbeam comprises:
an end portion;
a tip protruding from a base region of the end portion;
a channel along the micro beam and in fluidic connection with the base region, wherein the channel has a side wall; and
wherein the base region is recessed from an outer surface of the side wall and extends to at least one side of the end portion.

22. The system of claim 21, wherein the base extends to three sides of the end portion.

23. The system of claim 21, wherein the base extends to three sides of the end portion, and wherein the base is formed by masking the end portion completely.

24. The system of claim 21, wherein the channel is tapered and has a gradually narrowing width toward the base region.

25. The system of claim 21, wherein the base is configured to draw the fluid from the channel by a surface tension difference between the fluid over the base and the fluid in the channel.

26. The system of claim 21, wherein the base region comprises an enlarged portion of the channel, and wherein the enlarged portion has at least one side without a side wall.

27. The system of claim 21, wherein the base region has a lateral surface substantially flush with the bottom surface of the channel.

28. The system of claim 21, wherein the tip is integrally formed with the base region.

29. The system of claim 21, wherein the tip has a height of about at least about 3 microns from the base region.

30. The system of claim 21, wherein the array includes at least ten microbeams.

31. A method of printing a microscopic or nanoscopic pattern on a surface, the method comprising:
depositing a fluid from a channel in a cantilever to the surface at an end portion of the cantilever;
wherein the end portion comprises a base region having a tip thereon, and wherein the base region has no boundary at least at one side or has a side wall substantially lower than a side wall of the channel.

32. The method of claim 31, wherein said depositing comprises drawing the fluid from the channel toward the base region through a surface tension difference between the fluid in the base region and the fluid in the channel.

33. The method of claim 31, further comprising moving the cantilever end portion relative to the surface so that the fluid is delivered from the cantilever end portion to the surface.

34. The method of claim 31, wherein the fluid forms a feature on the surface with a width of about one micron to about 100 microns.

35. The method of claim 31, wherein the fluid forms a feature on the surface with a width of about one micron to about 15 microns.

36. The method of claim 31, wherein said depositing comprises contacting the cantilever and the surface.

37. The method of claim 31, wherein the fluid is an aqueous fluid.

38. The method of claim 31, wherein the fluid comprises at least one biomolecule.

39. The method of claim 31, wherein the fluid comprises at least one protein.

40. The method of claim 31, wherein the cantilever is part of an array of cantilevers.

41. A method of manufacturing a micro cantilever, the method comprising:
providing an elongated beam having an end portion;
forming a tip at the end portion;
apply a mask having a tapered channel region along the beam, wherein the mask portion for the channel has an expanded portion that substantially encloses the end portion; and
etching the elongated beam to form the tapered region and to a base region corresponding the expanded portion, wherein the base region extends completely through at least one side of the end portion.

42. A device comprising:
a cantilever including:
a channel;
two side wall areas sandwiching the channel;
an optional tip disposed at a free end portion of the cantilever; and
a broadened channel area surrounding the tip;
wherein the broadened channel area extends completely through at least one side of the free end portion.

43. A method comprising:
providing a device according to claim 1,
disposing an ink in the channel and on the tip,
depositing the ink from the tip to a substrate.

44. A instrument adapted for printing an ink onto a substrate and comprising the device of claim 1.

45. A kit comprising the device of claim 1.

46. The kit of claim 45, wherein the kit further comprises instructions for use of the device of claim 1.

47. The kit of claim 45, wherein the kit further comprises an ink for use with the device of claim 1.

48. A method comprising:
loading at least one ink onto a device comprising a plurality of cantilevers comprising at least one tip on each cantilever,
depositing the ink from the plurality of cantilevers and tips to a substrate,
wherein at least 80% of the tips show successful deposition of the ink onto the substrate.

49. The method of claim 48, wherein at least 90% of the tips show successful deposition of the ink onto the substrate.

50. The method of claim 48, wherein the cantilever is a cantilever according to claim 1.

51. The method of claim 48, wherein the method is used to pattern over 1,000 features, and over 80% of the features are successfully patterned.

52. The method of claim 48, wherein the method is used to pattern over 1,000 features, and over 90% of the features are successfully patterned.

53. The method of claim 48, wherein the method is used to pattern over 1,000 features, and over 95% of the features are successfully patterned.

54. A device comprising: an elongated cantilever having a first surface and a second surface, wherein the cantilever comprises: at least one tip disposed at an end portion of the cantilever; a recessed area on the first surface, wherein the recessed area comprises: a first elongated portion along the length direction of the cantilever; and a second expanded portion around the tip.

55. The device according to claim 2, wherein surface tension drives fluid from the channel toward the base region.
